(19) United States
(12) Patent Application Publication
(10) Pub. No.: US 2016/0366602 A1
(43) Pub. Date: Dec. 15, 2016

(54) SOLAR SYSTEM WITH REDUNDANT DATA CONNECTION

(71) Applicant: Vivint Solar, Inc., Lehi, UT (US)

(72) Inventors: Daniel Rapp, Lehi, UT (US); Willard S. MacDonald, Sebastopol, CA (US); Roger L. Jungerman, Petaluma, UT (US)

(21) Appl. No.: 15/176,771

(22) Filed: Jun. 8, 2016

Related U.S. Application Data
(60) Provisional application No. 62/172,945, filed on Jun. 9, 2015.

(51) Int. Cl. H04W 24/04; H04L 12/773

(52) U.S. Cl. CPC H04W 24/04; H04L 45/60; H04W 88/085

(57) ABSTRACT

The present disclosure is directed to a methods, devices, and systems communicatively coupling a solar system to a network. A system may include a local router and a solar gateway. The solar gateway may include an interface for coupling to a network via the local router and a long-range module for coupling to the network via at least one other solar gateway.

### CROSS-REFERENCE TO RELATED APPLICATIONS

This application claims the benefit of and priority to U.S. Provisional Application No. 62/172,945, filed Jun. 9, 2015, and titled “Solar System with Redundant Data Connection,” and is incorporated herein by reference.

### TECHNICAL FIELD

This disclosure relates generally to communicatively coupling a solar system to a network, and more specifically to coupling a solar system to a network via one of a plurality of possible communication paths.

### BRIEF SUMMARY

In one specific embodiment, a system includes a local router and a solar gateway including an interface for coupling to a network via the local router. The solar gateway further includes a long-range module for coupling to the network via at least one other solar gateway.

In another specific embodiment, a system includes a network and a solar gateway configured to provide a plurality of communication paths between the solar gateway and the network. During a contemplated operation of the system, one of the plurality of communication paths may be used for transmitting data from the solar gateway to the network.

According to other embodiments, the present disclosure includes methods for communicatively coupling a solar system to a network. Various embodiments of such a method may include conveying data from a solar system to a network via a first communication path. The method may also include conveying data from the solar system to the network via a second, different communication path upon failure of the first communication path. In one embodiment, the method may also include conveying data from the solar system to the network via a third, different communication path upon failure of the first and second communication paths.

In accordance with another embodiment, a method includes routing data from a solar gateway to a network via a path including a local router. Further, the method may include routing data from the solar gateway to the network via a path including a local long-range radio, at least one remote long-range radio, and a remote router. In one specific embodiment, the method may include routing data from the solar gateway to the network via the path including the local long-range radio, the at least one remote long-range radio, and the remote router upon failure of the path including the local router.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1 depicts a system including a solar gateway, according to an embodiment of the present disclosure;

FIG. 2 illustrates a network including a group of solar gateways, in accordance with an embodiment of the present disclosure;

FIG. 3 is a flowchart depicting a method, in accordance with an embodiment of the present disclosure; and

FIG. 4 is a flowchart depicting another method, according to an embodiment of the present disclosure.

### DETAILED DESCRIPTION

Referring in general to the accompanying drawings, various embodiments are illustrated to show the structure and methods for communicatively coupling a solar system to a network (e.g., the Internet) (e.g., with the purpose of ultimately coupling the solar system to a server enabled to collect and/or process information about the operation of the solar system). Common elements of the illustrated embodiments are designated with like numerals. It should be understood that the figures presented are not meant to be illustrative of actual views of any particular portion of the actual device structure, but are merely schematic representations which are employed to more clearly and fully depict embodiments.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Solar photovoltaic (PV) cells use light energy (photons) from the sun to generate electricity through a photovoltaic effect. A PV solar module includes PV cells mounted behind glass and typically includes a frame at least partially surrounding the edges of the cells and glass. A PV system, which may include a plurality of solar modules and various other electrical components (e.g., one or more inverters, monitoring and control device, and other balance of system (“BOS”) components such as racking, wiring, AC disconnects, etc.), may be used to generate and supply electricity in utility, commercial and residential applications.

Solar system installation companies, which finance the installation of solar systems (e.g., on residential homes), typically own solar assets for 25 years or more. Revenue for these installation companies may depend on the monitoring and long-term performance of these assets. Conventionally, monitoring data, related to the health and performance of a solar system, is transferred to servers on the Internet (i.e., in the cloud). Monitoring data may be used to bill a homeowner (e.g. when a power purchase agreement (“PPA”) is part of the installation contract), and/or to monitor the health or performance of the solar system. In addition to enabling data to be uploaded, the data path to/from the cloud (i.e., a gateway) may also be used to upload weather, per-module information, inverter fault codes, or other information about the solar system and/or equipment. In addition to monitoring the solar system, the gateway may also be used to control the solar system. For example, a remote operator or a software program may make changes to the inverter settings or other hardware or software via the gateway.

Traditionally, a homeowner's broadband internet router is used as the gateway for a solar monitoring system. The interface to the router may be directly to the router via, for example, an Ethernet cable, or it may be via a Wi-Fi network. Wi-Fi is a local area wireless computer network (e.g., as defined by IEEE 802.11). Using a local router and/or Wi-Fi is convenient for a solar system installation company because it is a low cost means of connecting the solar system to a remote network (e.g., the cloud). The homeowner may be required to allow this data connection as part of a contract between the solar company and the homeowner. However, homeowner internet connections are notoriously unreliable. Home Wi-Fi passwords are changed often (e.g., once per year). Furthermore, local (e.g., home, on the property, or co-located with the solar system) routers are often unplugged due to being moved or replaced. In addition, local routers may not be set up so as to be compatible with a solar monitoring system (or the setup may be changed so as to become incompatible) and, thus, the cloud connection may be lost. As will be appreciated, homeowners tend to notice when the internet connection to their computer or smartphone is lost, but may be less likely to notice if the connection from the solar monitor system to the cloud is lost. Hence, the data connection that is business critical to the solar system installation company is unreliable and not in the installation company's control. Furthermore, a homeowner may not be motivated to maintain the connection for solar monitoring.

Some solar equipment and solar installation companies have used cellular modems in place of, or in addition to, a home router connection. This may improve reliability of the cloud connection because it is separate, or redundant to, the homeowner's router. However, cellular modems are expensive, costing, for example, $50 to $100 per system, and typically require a data plan with a cellular carrier costing, for example, $0.50 to $2.00 per meter per month. Over a 25 year life of a solar system, a data plan may therefore cost, for example, $150 to $600. Also, the coverage of cellular carriers may not overlap well with the regions desirable for solar installations. Furthermore, cellular protocols are expected to have a limited life before becoming obsolete (e.g., 3G may become obsolete in or around the year 2020 and 4G/LTE may become obsolete in or around the year 2027). When a cellular network becomes obsolete, the solar system installation company may be required to visit the site on a service trip to update the cellular modem to a new protocol. Each service trip may cost, for example, $300.

Various embodiments of the disclosure are related to devices, systems, and methods, which incorporate a low cost, high reliability gateway that is not dependent solely on a local (e.g., home) router connection and may not incur the costs and coverage issues of a cellular connection on every solar system.

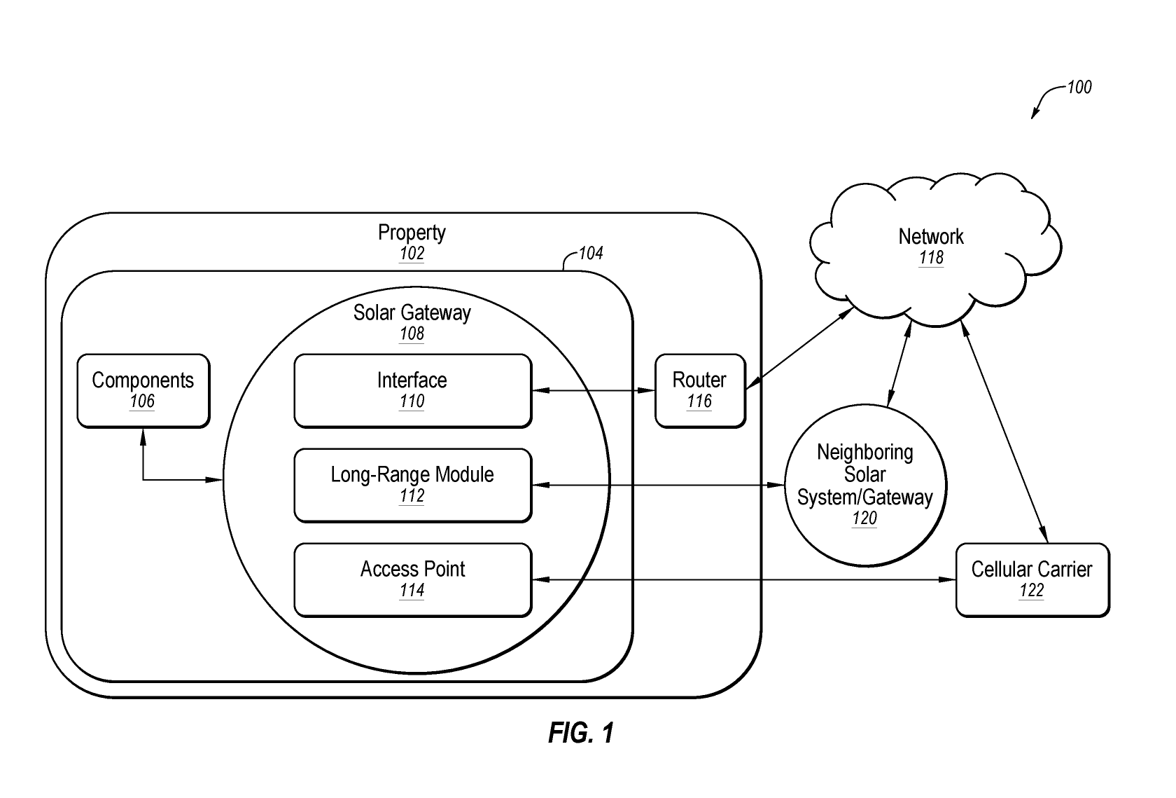

FIG. 1 illustrates a system 100, in accordance with various embodiments of the present disclosure. According to one or more embodiments, system 100 includes a property 102, which includes a solar system 104. As a non-limiting example, property 102 may comprise a residential property or a commercial property. Solar system 104 may include components 106, which may comprise, for example, an inverter and other devices (e.g., monitoring and control devices and other BOS components such as racking, wiring, AC disconnects, etc.). Solar system 104 further includes a solar gateway 108 (also referred to herein as a “monitoring and control gateway” or a “gateway”) that comprises an interface 110, a long-range module 112, and an optional group access point 114. Property 102 may further include an internet router 116, which may be referred to herein as a “residential router,” a “home router” or a “local router.” Router 16 may be used as a primary connection to a remote network 118 (e.g., to the cloud). A connection to router 116 may comprise, for example only, an Ethernet or Wi-Fi connection.

As will be described more fully below, embodiments of the present disclosure provide multiple layers of redundancy for a data connection between solar system 104 and remote network 118 (e.g., the cloud). As illustrated in FIG. 1, system 100 includes a first connection from solar gateway 108 to network 118 via interface 110 and router 116. System 100 further includes another connection (i.e., a redundant or backup data route) from solar gateway 108 to network 118 via long-range wireless module 112, which is configured to communicate with a neighboring solar system 120 including a long-range module (e.g., including one or more long-range radios) and a local router of a neighboring solar system (i.e., a router local to the neighboring solar system). For example, long-range wireless module 112 may include one or more long-range radios (e.g., a 900 MHz radio) configured to transmit data (e.g., 200 meters or more). As will be understood, a 900 MHz radio may able to transmit data farther than, for example a 2.4 GHz radio, because the power of the lower frequency radio waves are less easily absorbed by obstructions in the environment. As will be appreciated by a person having ordinary skill in the art, solar system installation companies tend to install multiple solar systems within a given neighborhood and, therefore, develop clusters of systems where a majority of systems in the cluster may be, for example, within 200 meters from at least one other neighboring system.

During a contemplated operation of system 100, if a connection between interface 110 and network 118 (i.e., via router 116) is lost, solar gateway 108 may be configured to transmit data via long-range module 112 to neighboring solar gateway 120 (i.e., it may “hop”), which may enable for communication between solar gateway 108 and network 118 via a neighboring solar system's gateway and local router. If the neighboring system's local router connection is lost, solar gateway 108 may further hop to yet another neighboring solar system. Accordingly, the original solar gateway (e.g., solar gateway 108) may find a route to network 118 (e.g., the Internet and the cloud) by hopping from solar router to solar router on neighboring systems until a live internet connection via an operable local router is discovered. The solar gateways may hence be thought of as providing a redundant network of connections to the cloud.

In accordance with another embodiment, a long-range module (e.g., long-range module 112) may also enable a solar gateway (e.g., solar gateway 108) to communicate with other parts of a solar system (e.g., components 106). For example, a revenue-grade AC production meter may be polled periodically, and solar electric production data may be incorporated into the data stream communicated to the cloud (e.g., network 118). In addition to monitoring AC production of the solar system, other data collected by the solar system can also be included in the data stream. This data may optionally include the DC string voltage and/or current of the solar system, the inverter temperature, any inverter error codes, and/or information about any local storage devices, such as batteries. The inverter may have an optional AC consumption monitor that measures the AC power use at the property where the solar gateway is installed. This AC consumption data can also be included in the data stream. Optionally, the AC consumption data can come from a separate AC consumption meter that communicates with the solar gateway. Further, there may be electronics on a roof that may provide information related to, for example, module-level AC production, DC-production, I-V curves, temperature data, irradiance data, etc. This data may also be incorporated into the data stream communicated to the cloud via one or more long-range radios.

A long-range radio (or its antenna) positioned on a roof may act as another relay to a neighboring solar gateway. By having a communication link (e.g., a radio link) on the roof, the range of the communication link from property to property (e.g., from house to house) may be significantly increased. It is noted that the radio range may be dependent on the Fresnel beam shape of the transmitting and receiving radios. The communication link range may be increased with larger distance between a radio-frequency antenna and the ground. In addition, a roof-top long-range radio may have fewer obstructions, such as building walls, or roofing material, which may impede the long-range radio transmission. A roof-top long-range radio may be more likely to have direct line-of-sight to a neighboring solar system, which may significantly increase the range of the radio link while maintaining acceptable signal strength.

In another embodiment, solar system 104 may further include another layer of redundancy in the form of another, independent data path from solar gateway 108 to network 118. This alternate data path includes a group access point 114 configured to provide network access (i.e., access to network 118) for a group of solar gateways. For example, group access point 114 may comprise a cellular modem and communication from group access point 114 to network 118 may be provided via, for example only, a cellular carrier 122. In other embodiments, group access point 114 may comprise a satellite modem, a fiber optic link, a microwave link, or another type of backhaul.

By way of example only, if all local router internet connections within a group of solar gateways fail, the solar gateways may route data through group access point 114 by sending data packets that “hop” from solar gateway to solar gateway until they reach a group access point (e.g., group access point 114). This approach may, for example, minimize the use of cellular modem hardware and the cellular data plan while benefiting from the reliability of a cellular link. A number of group access points may be small relative to the number of solar gateways within a group. For example, the number of cellular modems may be 5% or less of the number of solar gateways in a group of solar gateways. As an example, a system may include at least one group access point for any group of solar gateways (including a group of one). As a more specific example, a system may include at least one group access point for every 50 solar gateways in a group of solar gateways.

When each solar gateway within a group has lost its local router connection and, for example, a cellular access point is providing the data path connection to a network (e.g., network 118), a data rate plan fee may be charged by a cellular carrier. This may trigger the solar system installation company to repair one or more of its home router connections. This repair could entail calling a homeowner to walk them through a fix over the phone, updating a Wi-Fi password, and/or physically visiting the site to troubleshoot the problem. The cost/benefit tradeoff of the repair versus the cellular plan charges may be made by the solar system installation company.

In one embodiment, when data is being routed through a cellular access point (e.g., group access point 114), an amount of data transmitted may be reduced to lower data plan charges. For example, if production data is normally transmitted every 15 minutes giving 15 minute resolution production data, when a cellular access point is in the data path, the data may be sent once daily, giving 24 hour resolution production data. Hence, if the 15 minute data was nominally being transmitted 12 hours per day, the data bandwidth requirements would be reduced by a factor of 48. In another embodiment, a business arrangement (i.e., an agreement) may be made with a cellular carrier in which data transmissions made late at night, when most cell phone users are not using the bandwidth, is less expensive than data transmitted during the day. In this embodiment, a solar gateway may log data and transmit all the day's data after a “night” rate begins.

In another embodiment, an amount of data transmitted via a cellular modem may be reduced by sending high resolution production data only when a problem is detected by the system or the solar gateway. Under normal operation, for example, only daily data is transmitted, however, if a problem is detected then data may be sent at a higher resolution. It may be appreciated that it is challenging for an individual system to detect some problems, such as reduced energy production, without comparison to a weather-corrected reference. A weather corrected reference may be generated by incorporating irradiance and temperature sensors or a weather station local to the solar system. However, this may add significant cost to the system. In one embodiment of the present disclosure, the weather-corrected-reference may be determined from one or more neighboring systems by communicating via the long-range radio. The solar gateway may pole a neighboring system and compare its own production to the production of the neighboring system. Since typically the neighboring systems will have experienced similar weather, they can provide the reference from which to determine whether there is a problem with the local system. The details of the system must be accounted for to translate the production of one system to that of another.

In general, a model of the neighboring system (e.g. number of modules, orientation of modules, etc.) may be used to extract an estimate of the irradiance (e.g. direct and diffuse) impinging on the system and the temperature of the modules. This irradiance and temperature may then be used to predict what the local system should be producing based on its own system model. By analyzing one or more neighboring systems, an average irradiance and temperature profile may be generated that may be more reliable than from a single system. Since the communication between neighboring systems is via the long-range radios, the use of the cellular network is minimized thus reducing data plan costs. In general, data may be transferred from one solar gateway to another solar gateway within one or more hops via a long-range radio without going through a router or group access point. This data may include information about one or more solar systems, storage systems, or weather at one or more site. For example, cloud movement may be tracked as it passes over a neighborhood by monitoring the electrical current produced by solar systems in the region. The current will drop as the cloud shades the array. If the geographical location of systems is known then the trajectory of the cloud movement may be detected and its future direction may be predicted. This may be used to predict when the cloud may pass over a particular system. This information may then be further used, for example, to adjust energy storage behavior and battery management, energy import/export (e.g. from/to grid), or home cooling/heating settings. For example, a cooling cycle may be delayed by a smart thermostat if a cloud is expected to pass overhead soon since a cloud will naturally provide cooling to the home. This may result in a more optimal thermostat control.

In accordance with various embodiments of the present disclosure, a solar gateway (e.g., solar gateway 104) may strike a balance between cost and reliability. More specifically, the solar gateway may make use of a low cost local router connection when it is available, but provide an alternate path to at least one other solar gateway in a vicinity via a long-range module (e.g., long-range module 112). Another solar gateway, in turn, either provides a live local router connection or provides another alternate path via its long-range module to yet another solar gateway. If no solar gateways in a group of solar gateways (i.e., solar gateways reachable by hopping) have a live local router connection, a group access point (e.g., group access point 114) may be used. If the group access point fails for some reason, such as the cellular carrier technology becomes obsolete, only that single device (e.g. that single cellular modem) must be repaired or replaced.

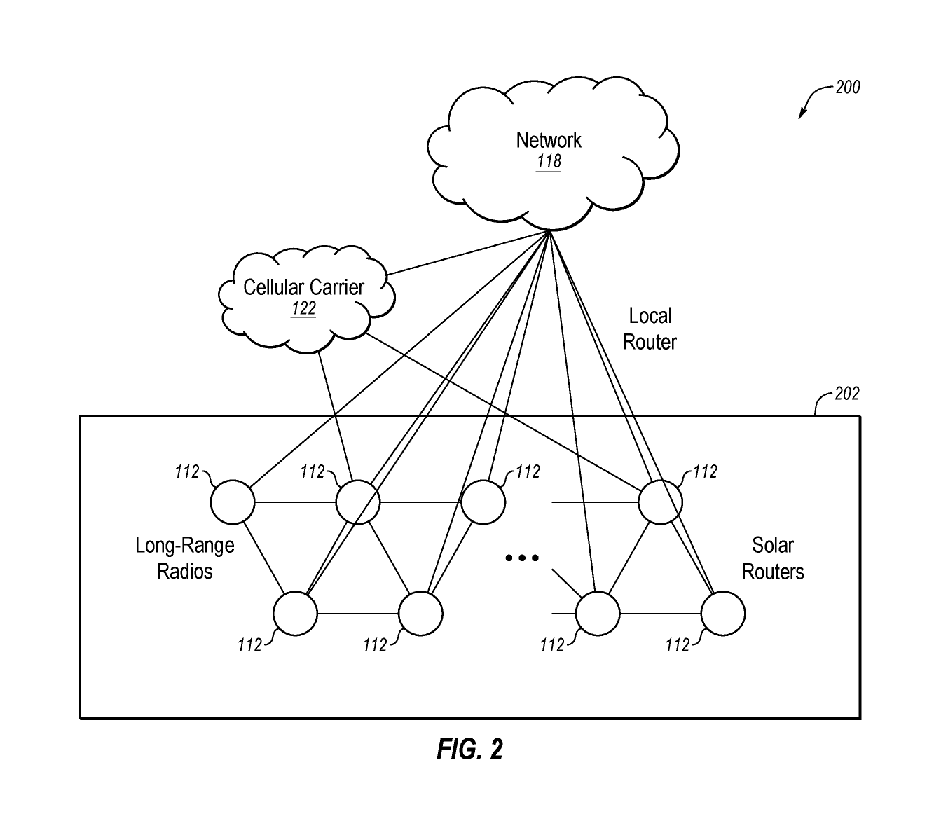

FIG. 2 depicts a network 200 including a group of solar gateways 202, according to an embodiment of the present disclosure. Network 200 includes a plurality of long-range modules 112, wherein each long-range module 112 may include, for example only, one or more long-range radios. Further, each solar gateway 202 may be configured to access network 118 (e.g., the cloud) via a local router. More specifically, each solar gateway 202 may be configured to access network 118 via an associated local router (i.e., a router located at the same property) or via a solar gateway and home router of a neighboring solar system. Network 200 further includes a cellular carrier 122 configured to provide communication between one or more solar gateways of a group and network 118.

As discussed earlier, in the event that a first solar gateway loses its network connection (e.g., connection to the cloud) via its local router, it may re-route its data through a long-range module (e.g., including a long-range radio) to a second, nearby solar gateway. If this second solar gateway has a local router connection, then the data from the first solar gateway may be routed through the second solar gateway's local router connection. In one embodiment, a business arrangement (i.e., agreement) with homeowners may be established to allow transmission of third-party data via the homeowner's solar gateway, local router, or both. The agreement may allow transmission of third party data as a primary data path to the network or as a redundant data path to the network for the third party's data. The third party may be one or more of: a solar system installation company, a system owner (e.g. an energy company, a bank, or a residential solar financier), and one or more other homeowners (e.g. neighboring homeowners with solar gateways installed on their properties that may be in signal communication via one or more hops over long range radio). Such an agreement may be included in a PPA that the homeowner may otherwise sign with the solar installation company or it may be a separate agreement. Such an agreement may be required as part of the solar project.

Appropriate security measures may be taken to isolate or safeguard one homeowner's data from another homeowner whose solar gateway or solar gateway plus local router may be utilized. The data may include the solar system data or any other data owned by the homeowner. The data may also include control data meant to control one or more aspect of the solar system. Security measures may prevent a user from accessing the computer equipment, smartphone, or solar equipment of another user (e.g. homeowner). Security measures may also limit the access to the network or network equipment (e.g. router) of another user such that access can only be made under the control of the solar gateway with limited control. Security measures may include encryption, password protection, electronic keys, physical isolation (e.g. isolated electrical paths for the data), etc.

In another embodiment, a solar gateway may be used to transmit home security or home automation data to a network (e.g., the cloud). Home security may require a reliable connection to the Internet. Traditionally this connection is via a homeowner's phone line or via a cellular modem. The solar gateway may provide a reliable, low cost alternative to these data paths. Home automation data can include, for example, data from a home thermostat that can be used to modify a home AC consumption profile by appropriately timing the “turn on” and “turn off” of the HVAC system or water heater. This can enable the home AC consumption profile to better match the photovoltaic AC production of the solar system. Thermostat data can be combined into the data stream into the solar gateway.

In another embodiment, the solar gateway may be used to provide redundant general purpose internet access. For example, if the home owner's general purpose internet access (e.g. for web browsing, entertainment, etc.) is lost, an alternate internet connection may be provided to the homeowner via the long-range radio and one or more remote solar gateways and remote router.

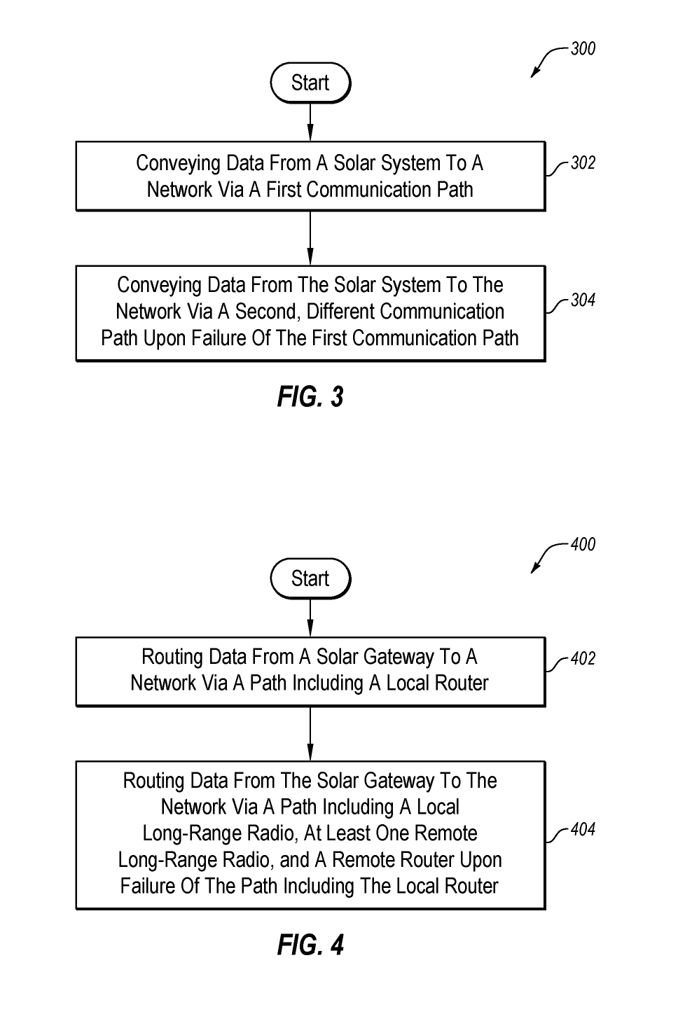

FIG. 3 is a flowchart of a method 300, according to an embodiment of the present disclosure. Method 300 may include conveying data from a solar system to a network via a first communication path (depicted by act 302). Method 300 may further include conveying data from the solar system to the network via a second, different communication path upon failure of the first communication path (depicted by act 304). Failure of the first communication path may be due to failure of the local router, failure of interface 110 (see FIG. 1), or any other failure that causes the connection to the network via the local router to be lost.

Modifications, additions, or omissions may be made to method 300 without departing from the scope of the present disclosure. For example, the operations of method 300 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

FIG. 4 is a flowchart of another method 400, according to another embodiment of the present disclosure. Method 400 includes routing data from a solar gateway to a network via a path including a local router (depicted by act 402). Method 400 further includes routing data from the solar gateway to the network via a path including a local long-range radio, at least one remote (e.g. not co-located with the solar system or solar gateway) long-range radio, and a remote router upon failure of the path including the local router (depicted by act 404). Method 400 may further include routing data from a solar gateway to the network via a path including a group access point upon failure of both the path including the local router and the path including the long-range radio. Failure of the path including the long-range radio may be due to failure of the long-range radio, failure of remote router associated with the remote long-range radio, failure of all remote routers associated with all remote long-range radios reachable by hopping, or any failure that eliminates the ability of the solar gateway to reach the network via the long-range radio.

Modifications, additions, or omissions may be made to method 400 without departing from the scope of the present disclosure. For example, the operations of method 400 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed:

1. A solar system, comprising:
a local router; and
a solar gateway including:
an interface for coupling to a network via the local router; and
a long-range module for coupling to the network via at least one remote solar gateway.

2. The solar system of claim 1, wherein the solar gateway further includes a group access point for coupling to the network.

3. The solar system of claim 2, wherein the group access point comprises a cellular modem.

4. The solar system of claim 2, wherein the group access point is configured to couple to the network via a cellular carrier.

5. The solar system of claim 1, wherein the long-range module includes at least one long-range radio.

6. The solar system of claim 5, wherein the at least one long-range radio comprises at least one 900 MHz wireless radio.

7. The solar system of claim 1, wherein the at least one long-range module is configured to communicate with the at least one remote solar gateway of another solar system when the connection to the network via the local router is lost.

8. A solar system, comprising:
a network; and
a solar gateway configured to provide a plurality of communication paths between the solar gateway and the network.

9. The solar system of claim 8, the plurality of communication paths comprising:
a first path for coupling to the network via a local router; and
a second path for coupling to the network via at least one long-range radio.

10. The solar system of claim 9, wherein data is conveyed via the second path when connection to the network via the first path is lost.

11. The solar system of claim 9, the plurality of communication paths further comprising a third path including a group access point for coupling to the network.

12. The solar system of claim 11, wherein data is conveyed via the third path when all connections to the network via a local router are lost.

13. The solar system of claim 8, further comprising a group of solar gateways including the solar gateway, wherein less than 5% of solar gateways with the group of solar gateways include a group access point.

14. The solar system of claim 8, further comprising a local router coupled to the solar gateway via at least one of an Ethernet and a Wi-Fi connection.

15. The solar system of claim 8, further including at least one additional solar gateway configured to communicate with the solar gateway and the network.

16. The solar system of claim 8, further comprising one or more electrical components coupled to the solar gateway, the solar gateway configured to receive data from the one or more electrical components.

17. A method, comprising:
conveying data from a solar system to a network via a first communication path; and
conveying data from the solar system to the network via a second, different communication path upon failure of the first communication path.

18. The method of claim 17, wherein conveying data from a solar system to a network via a first communication path comprises conveying the data from the solar system to the network via a router local to the solar system.

19. The method of claim 17, wherein conveying data from the solar system to the network via a second, different communication path comprises conveying the data from the solar system to the network via at least one long-radio radio and a router remote from the solar system.

20. The method of claim 19, further comprising establishing an agreement between a plurality of parties to enable a first party of the plurality of parties to use a router of at least a second party of the plurality of parties as part of the second, different communication path.
